(19) United States
(12) Patent Application Publication
(10) Pub. No.: US 2003/0224721 A1
(43) Pub. Date: Dec. 4, 2003

(54) Method and providing wireless-controlled wireless extension service

(76) Inventors: Ronald Bruce Martin, Carol Stream, IL (US); Randall Joe Wilson, Naperville, IL (US)

Correspondence Address: Lucent Technologies Inc., Docket Administration, (Room 3J-219), 101 Crawfords Corner Road, Holmdel, NJ, 07733-3030, US

(21) Appl. No.: 10/159,490

(22) Filed: May 31, 2002

(51) Int. Cl. H04B 7/14

(52) U.S. Cl. 455/11.1; 455/7

(57) ABSTRACT

The present invention provides a method to allow mobile stations in a wireless communications system to act as extension units to each other. A first mobile station receives a call request. The first mobile station determines if extension functionality is enabled. If wireless extension functionality is enabled, the first mobile station determines which other mobile stations are in the extension member list. The first mobile station alerts other mobile stations in the extension list. The other mobile stations return instructions as to the disposition of the call. Those accepting the call are bridged onto the call and notified when the call ends. Inclusion of determination of the geographical location of other mobile stations allows call alerting to be restricted to mobile stations within a predetermined geographic location.

### CROSS-REFERENCE TO RELATED APPLICATIONS

The present application is related to application Ser. No. ______ , entitled “METHOD OF PROVIDING NETWORK-BASED WIRELESS EXTENSION SERVICE”. The above patent application is filed on the same day as the present application, assigned to the assignee of the present application, and incorporated by reference herein.

### FIELD OF THE INVENTION

This invention relates generally to the field of wireless communication systems, and more particularly utilizating wireless phones as extension phones for each other.

### BACKGROUND OF THE INVENTION

Existing analog wireline extensions allow multiple wireline phones to be alerted by an incoming call. In addition, multiple of these wireline extensions can participate in a single call. one limitation to wireline extension phones is that once a phone is engaged in a call, the other phones can participate in the ongoing call but cannot participate in a different call.

In current wireless communication systems, no such extension capability exists. A call destined for a mobile station alerts only that station and only that station can participate in the session.

Therefore, a need exists for a method and apparatus that allows mobile stations to be simultaneously alerted when a call is destined for a member of the group. Further, a need exists for a method that allows multiple wireless phones to be involved in such a call. In addition, a need exists for a method that allows multiple mobile stations to participate in a single call.

### BRIEF SUMMARY OF THE INVENTION

The present invention provides a method for providing extension functionality to multiple mobile stations. The users of the mobile stations are all alerted when a call is destined for any of the extension members. Each user can then decide whether to join the call. In an exemplary embodiment of the present invention, each mobile station maintains its individuality and can initiate or receive calls without invoking the extension functionality. In a further exemplary embodiment, via the use of physical location of the mobile stations, only extension members within a certain geographical location will be afforded extension functionality.

In accordance with an exemplary embodiment of the present invention, a mobile station stores a list of identities of the members of the extension group. These identities can be E.164 numbers or any other unique identifiers. When alerting of an incoming call arrives at the mobile station, the mobile station locally bridges the call to a “one-to-many” call and causes alerting to be sent to other extension members.

Further, the mobile station can perform a location determination on the extension members and only bridge the call to other extension members located within a predefined distance of the called mobile station. A unique alerting display is used at the other extension mobile stations to indicate that this is an extension call and not a direct call to those other mobile stations. Extension functionality can be disabled at each mobile allowing completely independent operation.

Advantageously, such an arrangement gives mobile station users the functionality of extension phones and allows the mobile stations to also be used in an independent mode.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flow chart of a method for processing a call request in a first mobile station in accordance with an exemplary embodiment of the present invention.

FIG. 3 depicts a flow chart of a method for processing, in mobile stations that are members of an extension group, a call request generated by the extension functionality in accordance with an exemplary embodiment of the present invention.

### DETAILED DESCRIPTION OF THE INVENTION

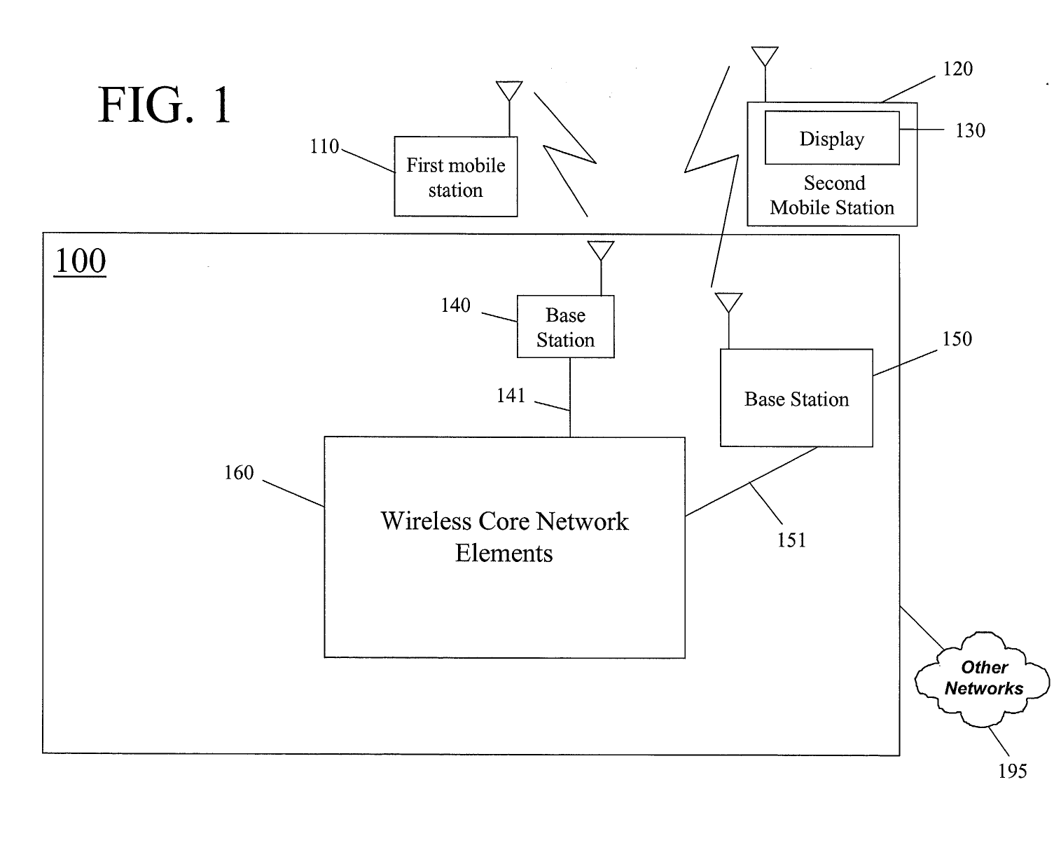

FIG. 1 depicts a communication system 100 in accordance with an exemplary embodiment of the present invention. Communication system 100 includes base stations 140 and 150 and wireless core network elements 160. Wireless core network elements 160 comprise known functions necessary to operate and maintain a wireless communication network. Communication system 100 is coupled to external networks 195, which can include other wireless networks and/or a Public Switched Telephone Network (PSTN).

Base stations 140 and 150 are coupled to wireless core network elements 160 via links 141 and 151 and provide over-the-air communications with a plurality of mobile stations, such as first mobile station 110 and second mobile station 120. It should be understood that communication system 100 can include a plurality of wireless core network elements and base stations. Only a single block of wireless core network elements 160 and two base stations 140 and 150 are depicted in FIG. 1 for clarity.

In the embodiment depicted in FIG. 1, first mobile station 110 and second mobile station 120 are coupled to and communicating with communication system 100. It should be understood that in an actual wireless network a plurality of mobile stations are coupled to the network via base stations. Only two mobile stations 110 and 120 are depicted in FIG. 1 for clarity. As depicted in FIG. 1, first mobile station 110 is communicating with base station 140 via an over-the-air interface. Second mobile station 120 is coupled to base station 150 via an over-the-air interface. The over-the-air interfaces can be the same or different. Also, it should be understood that first mobile station 110 and second mobile station 120 can be communicating with a single base station, such as base station 140. Mobile station 120 preferably includes a display 130 to visually display information to a user of mobile station 120.

In an exemplary embodiment of the present invention, first mobile station 110 receives an incoming call request. The call request can originate either within the wireless communications network or from other networks 195 that interface with wireless communication network 160, such as a Public Switched Telephone Network (PSTN). First mobile station 110 determines if extension functionality is enabled. If extension functionality is enabled, first mobile station 110 initiates wireless extension call requests to other mobile stations, such as second mobile station 120, that are stored in an extension list locally in first mobile station 110. The wireless extension call requests include an indication that the call request was generated by the extension functionality at first mobile station 110.

First mobile station 110 preferably can determine the geographical locations of mobile stations in the wireless extension group. First mobile station 110 may generate call requests only to other mobile stations within a predetermined geographical area. The location of the other mobile stations can be determined by first mobile station 110 using techniques such as cell and sector, time of arrival, and other similar location-finding techniques. These techniques rely on cooperation on elements such as base stations 140 and 150 and wireless core network elements 160 with the mobile stations in the wireless extension group.

An exemplary embodiment of the present invention includes determination of the locations of the mobile phones in the extension list. Without loss of generality or functionality, the called mobile station can, via existing means, request that the location step be bypassed.

The following are three representative examples for the use of geographical information used in extension functionality. First, extension service can be offered to mobile stations on a corporate campus. That is, only mobile stations located in the workplace at a given time would be offered extension service. Second, all mobile stations located at or near a residence can be offered extension service. In this way personal calls can be shared among mobile stations at the residence without interrupting mobile stations away from the residence. Finally, there can be no geographical limitations at all. All mobile stations in the extension list are alerted.

Upon receipt of the extension call request, second mobile station 120 alerts the user of the incoming extension call request. This alerting preferably occurs if the user is idle or is engaged in another call. Mobile station 120 displays call request information on display 130. The information indicates to the user that this is an extension call. Responsive to information on display 130, the user can specify, such as by depressing a keypad key, actions to be taken. In the preferred embodiment of the present invention, the user can specify the appropriate action to be taken by depressing a keypad key, but can alternately specify the appropriate action by issuing a voice command or any other method of inputting a command to second mobile station 120. Second mobile station 120 then informs first mobile station 110 via a call response of the desired action.

After receiving the call responses from the mobile stations that are extension members (in a manner analogous to that presented for mobile station 120), first mobile station 110 bridges the call to the mobile stations that are extension members, represented by other mobile station 120, which have indicated, within a predetermined time, that they would accept the extension call. If no other such stations accept the call, the call is completed as if it were only directed to mobile station 110. After the bridged extension call ends, first mobile station 110 notifies the other extension mobile stations that participated in the wireless extension call that the call has ended.

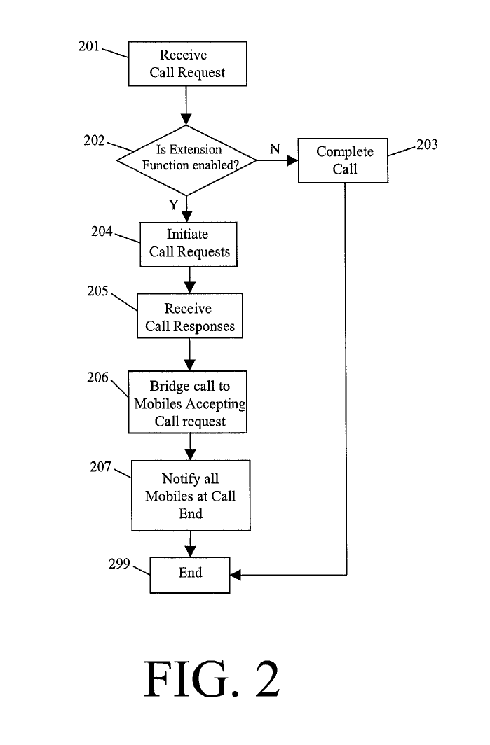

FIG. 2 depicts a flow chart 200 of a method for processing a call request in first mobile station 110 in accordance with an exemplary embodiment of the present invention.

First mobile station 110 receives (201) a call request. This call request can be for a voice, data, or multimedia call.

First mobile station 110 determines (202) if the extension functionality is enabled. The extension functionality can be enabled by the user of first mobile station 110. This can be done by methods such as depressing a keypad key. Extension functionality is preferably stored locally in mobile station 110. If the extension functionality is not enabled, fist mobile station 110 completes (203) the call normally, and the processing ends (299).

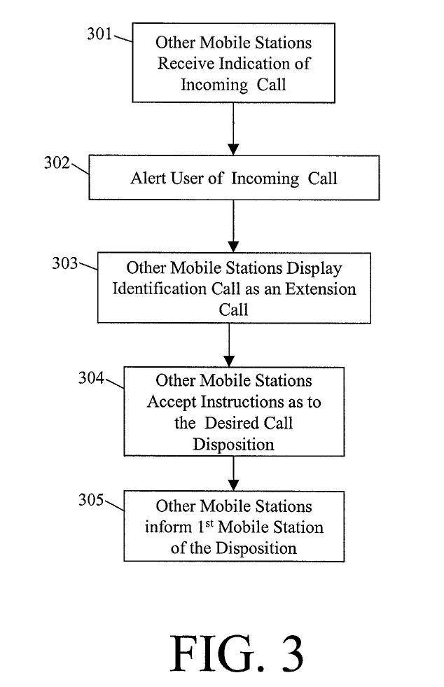

If the extension functionality is enabled as determined at step 202, first mobile station 110 initiates (204) call requests to other mobile stations that are on the extension list stored locally in first mobile station 110. In the process of initiating the call requests, first mobile station 110 may also determine the location of other mobile stations in the extension list and only send call requests to extension list mobile stations that are in a predetermined geographic area. The processing performed by a second mobile station 120 is depicted in FIG. 3.

Turning now to FIG. 3, FIG. 3 depicts a flowchart 300 of a method for processing in other mobile stations a call request generated by the extension functionality in accordance with an exemplary embodiment of the present invention. The other mobile stations in the wireless extension group receive (301) an indication of an incoming extension call.

Each mobile station alerts (302) the users of the mobile station of the incoming call. The alerting can be done visually, audibly, or via vibration. For example, the alert can be visual by lighting a light on the display of the mobile station, displaying an icon on the display of the other mobile station, or any other means of displaying information on the display to alert the user of the incoming call request. An alert can also be audible, such as a beep, tone, or tune played on the mobile stations. This audible alerting can be done via existing means currently used to cause tones/ringing sequences to be played at a mobile station.

The mobile station displays (303) an indication that this call is a wireless extension call. This is accomplished via any one of the existing means to display information on a mobile station, such as an icon on the display.

The mobile station accepts (304) instructions as to the desired disposition of the call. The user of each wireless extension phone can decide to accept the call or reject the call. If the user accepts the call request, the accepting mobile station will be bridged into the call by the first mobile station. If the user of the wireless extension phone does not respond within a predetermined period of time, the wireless phone is treated as if the call was rejected.

Each wireless extension mobile station informs (305) the first mobile station of the disposition of the call request.

Returning now to FIG. 2, first mobile station 110 receives (205) call responses from the mobile stations in the wireless extension group. If first mobile station 110 does not receive a response from a wireless extension member within a predetermined amount of time, first mobile station treats the lack of a response as the equivalent of a rejection from that wireless extension member. The predetermined period of time can be set to any time period that makes the lag time of the call responses acceptable to a user.

First mobile station 110 bridges (206) the call to the other mobile stations which indicated instructions to accept the call in the call response. In this manner the calling phone, the called wireless phone, and the accepting members of the wireless extension group are bridged together on a single phone call.

The call then proceeds as a multiparty call. When the callers wish to end the call, links are dropped as first mobile station 110 notifies (207) the other mobile stations that the call has ended. Processing of the call then ends (299).

The present invention thereby provides a method for providing extension capabilities to wireless mobile stations. By using the present invention, the user can be given the same functionality as is available with wireline extension phones. When coupled with the ability of determining the geographical location of other mobile stations, employee group members located at a corporate campus can be alerted to an incoming call, family members located at or near the residence can be alerted to an incoming call, or no geographical limitation may be imposed, thereby alerting all extension group members of an incoming call.

While this invention has been described in terms of certain examples thereof, it is not intended that it be limited to the above description, but rather only to the extent set forth in the claims that follow.

We claim:

1. A method of providing wireless extension service in a wireless communication system, the method comprising the steps of:
receiving an incoming call request from a calling phone at a first mobile station;
initiating bridging call requests from the first mobile station to other mobile stations included in an extension member list; and
bridging connections among all mobile stations accepting the bridging call request, the first mobile station and the calling phone.

2. A method of providing wireless extension service in accordance with claim 1, wherein the step of initiating bridging call requests comprises determining that wireless extension service is enabled.

3. A method of providing wireless extension service in accordance with claim 1, further comprising the step of enabling wireless extension service at the first mobile station.

4. A method of providing wireless extension service in accordance with claim 1, further comprising the step of disabling wireless extension service at the first mobile station.

5. A method of providing wireless extension service in accordance with claim 1, further comprising the step of determining if wireless extension service is enabled at the first mobile station prior to initiating call requests to the other mobile stations.

6. A method of providing wireless extension service in accordance with claim 1, wherein the step of initiating bridging call requests to other mobile stations comprises sending notification to the other mobile stations, wherein the notification includes an indication that this is a wireless extension call.

7. A method of providing wireless extension service in accordance with claim 1, wherein the step of initiating bridging call requests from the first mobile station to other mobile stations included in the extension member list comprises the step of determining if location determination of the mobile stations is enabled.

8. A method of providing wireless extension service in accordance with claim 7, wherein the step of initiating bridging call requests from the first mobile station to other mobile stations included in the extension member list comprises the step of determining the geographical location of the other mobile stations.

9. A method of providing wireless extension service in accordance with claim 8, wherein the step of initiating calls to other mobile station contained in the extension member list comprises initiating calls to other mobile stations located within a predetermined geographical location.

10. A method of providing wireless extension service in accordance with claim 1, wherein the step of bridging extension connections comprises sending call-end notification from the first mobile station to the other mobile stations when the incoming call has completed.

11. A method of providing extension functionality in a wireless communication system comprising a wireless network and a plurality of wireless mobile stations in communication with the wireless network, the method comprising the steps of:
receiving a bridging call request from a first mobile station;
determining that the call request was generated for a wireless extension call;
accepting instructions as to the completion of the call; and
returning the instructions to the first mobile station.

12. A method for providing extension functionality in accordance with claim 11, further comprising the step of receiving the call request if the instructions are to accept the call.

13. A method for providing extension service in accordance with claim 12, the method further comprising the step of accepting notification of the end of the call.

14. A method for providing extension functionality in accordance with claim 11, further comprising the step of displaying information relating to the call request.

15. A method for providing extension functionality in accordance with claim 14, wherein the information includes an indication that the call request is for an extension call.
